(19) United States
(12) Patent Application Publication
(10) Pub. No.: US 2011/0082733 A1
(43) Pub. Date: Apr. 7, 2011

(54) METHOD AND SYSTEM OF OFFERING AN ENVIRONMENTALLY SENSITIVE BANK ACCOUNT

(75) Inventor: Daniel Goldman, Kennett Square, PA (US)

(73) Assignee: CITIZENS FINANCIAL GROUP, INC., Providence, RI (US)

(21) Appl. No.: 12/969,040

(22) Filed: Dec. 15, 2010

Related U.S. Application Data
(63) Continuation-in-part of application No. 12/510,660, filed on Jul. 28, 2009.
(60) Provisional application No. 61/104,329, filed on Oct. 10, 2008.

(51) Int. Cl. G06Q 30/00; G06Q 40/00

(52) U.S. Cl. 705/14.17

(57) ABSTRACT

A method and system is provided whereby a customer either establishes a new account or converts their existing account into a program that maximizes the use of online bill payment, electronic statements and paperless charge transactions in exchange for reward payments. In accordance with the method and system, customers establishing or transferring to the program are provided with an electronic transaction card formed from 100% recycled plastic material, on-line banking and an electronic monthly statement thereby eliminating all of the paper associated with the management side of the account. Then customers who enroll receive an incentive for each and every payment or transaction that they complete without using paper.

### CROSS-REFERENCE TO RELATED APPLICATIONS

This application is a continuation in part of U.S. patent application Ser. No. 12/510,660, filed Jul. 28, 2009, which is related to and claims priority from earlier filed U.S. Provisional Patent Application No. 61/104,329, filed Oct. 10, 2008.

### BACKGROUND OF THE INVENTION

The present invention relates generally to a method and system for offering an environmentally friendly bank program. More specifically, the present invention relates to a bank program that encourages customers, through the use of a rewards system, to maximize their usage of the electronic features available to them in order to reduce the paper generated in the management of their account.

In the banking industry a tremendous amount of paper is generated that then must be handled, processed, transported and ultimately disposed of. In a traditional bank account, paper records are generated for each and every transaction. Further, paper is also used to track all of those transactions that are generated, to print bills and invoices relating to those transactions and to generate monthly statements to advise customers regarding their account activity during the previous month. Once all of these paper records are generated, they must be folded, placed into envelopes, postage must be applied and then the material must be delivered to the customer using fuel and additional resources. In this process, the average US family on an annual basis consumes nearly seven pounds of paper and 63 gallons of water. This is the equivalent of 24 square feet of forest per family each and every year for generating and tracking their bank account activity.

In addition to the environmental impact related to the generation and delivery of the paper associated with bank account activity, the cost of presenting and paying bills using traditional paper methods is astronomical. Billers, who often are billing small amounts with each transaction, must incur the costs of processing many checks, including the attendant overhead of dealing with remittance processing, such as opening envelopes, data capture of the consumer's account number, MICR (Magnetic Ink Character Recognition) encoding of the check amounts, etc. To ensure that the incremental cost of processing an item is small, billers have set up huge operations for remittance processing. As a result, most large billers (credit card, mortgage, car loans, student loans, etc.) and account service providers such as banks are interested in the creation of electronic, paperless alternatives that provide cost savings, revenue generation and image enhancement potential.

Clearly there are more and more electronic, paperless systems that are becoming available every day. Many banks are offering online banking solutions that are accessible via the Internet and service providers are accepting online payments. The problem is that many customers are resistant to changing over from the traditional paper methods with which they are accustomed thereby decreasing the realizable potential for saving resources and money.

As a result there is a need for a method and system for offering an environmentally friendly bank program that takes the greatest advantage of the available electronic and paperless systems in use today. Further, there is a need for a method and system of implementing an environmentally friendly bank program that encourages customers, through the use of a rewards system, to maximize their usage of the electronic features available to them in order to reduce the paper generated in the management of their account.

### BRIEF SUMMARY OF THE INVENTION

In this regard, the present invention provides a method and system that offers an environmentally friendly bank program in a manner that takes the greatest advantage of the available electronic and paperless systems in use today. More specifically, the present invention provides a method and system of implementing an environmentally friendly bank program that encourages customers, through the use of a rewards system, to maximize their usage of the electronic features available to them in order to reduce the paper generated in the management of their account.

In its most general form, the method and system of the present invention provides for a customer to either enroll a new account or convert their existing account into an program that maximizes the use of online bill payment, electronic statements and paperless charge transactions in exchange for reward payments. In other words, the bank is employing an incentive program to encourage the customer to transfer onto the new system and method.

Customers establishing or transferring to the account are provided with an electronic transaction card formed from 85% recycled plastic material, on-line banking and an electronic monthly statement thereby eliminating all of the paper associated with the ongoing management side of the account. The customers who enroll receive an incentive for each and every payment or transaction that they complete without using paper. For example, customers who enroll in the program may be paid 10 cents for every payment they make without paper, up to a total of $120 annually. In the context of the present invention, payments without paper include debit card transactions (both signature and PIN), online bill payments and all automatic payments charged to a checking account or debit card. The incentive is accumulated and deposited as cash directly into a customer's checking account on a monthly basis to provide greater savings and spending flexibility. To encourage true adoption of ‘paperless” payment habits, the customer must complete a minimum of 10 transactions to receive incentive payment.

In an alternate embodiment, the incentive is accumulated as described above and deposited as cash directly into a customer's checking account on a monthly basis. To further encourage savings, the customer also designates a savings account that is registered with the program. When the incentive is deposited into the checking account, the amount of the incentive and an amount equal to the incentive are deducted from the checking account balance and transferred as a deposit into the designated savings account. Still further, the bank service provider may provide an additional incentive in the form of a matching contribution as will be described in further detail below.

Additionally, the system of the present invention provides that all customers enrolled in the program will receive a monthly e-mail to notify them of their monthly incentive deposit, provide green living tips and let them know the impact their participation in the program has made on the environment. Finally, a website is also provided for customers to learn more about the program and how becoming eco-friendly can also be economical. At the website a calculator is provided to demonstrate to the customer the impact that going “paperless” will have.

Accordingly, it is an object of the present invention to provide a method and system for offering an environmentally friendly bank program that takes the greatest advantage of the available electronic and paperless systems in use today. It is a further object of the present invention to provide a method and system of implementing an environmentally friendly bank program that encourages customers, through the use of a rewards system, to maximize their usage of the electronic features available to them in order to reduce the paper generated in the management of their account.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting the method of the present invention; and

FIG. 2 is an apparatus depicting one possible embodiment for a system to implement the method of the present invention.

### DETAILED DESCRIPTION OF THE INVENTION

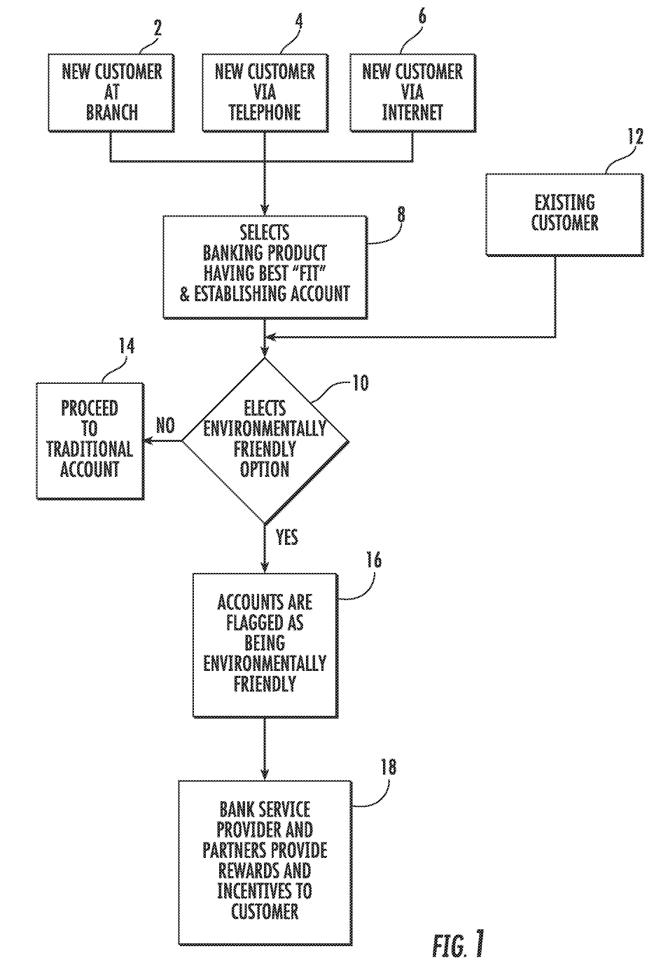

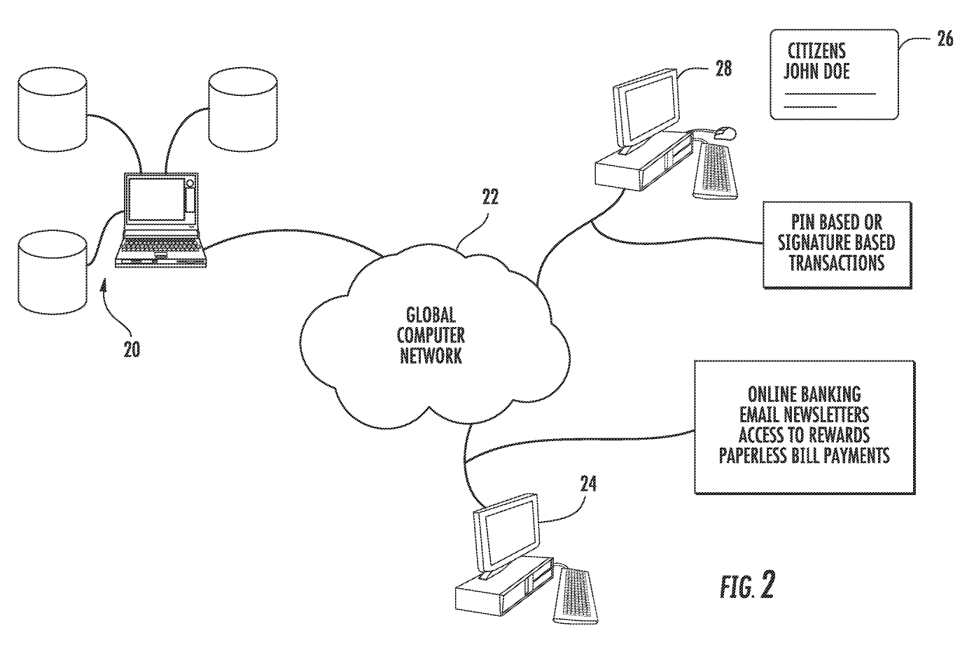

Now referring to the drawings, the present invention is depicted in the context of a method as shown at FIG. 1 and a system for implementing the method as depicted at FIG. 2. In this regard, the present invention provides a method and system that offers an environmentally friendly bank program in a manner that takes the greatest advantage of the available electronic and paperless systems in use today. Most generally, the present invention provides a method and system of implementing an environmentally friendly bank program that encourages customers, through the use of a rewards system, to maximize their usage of the electronic features available to them in order to reduce the paper generated in the management of their account.

Turning now to FIG. 1, the method of the present invention in its most general form provides for a bank service provider to establish a new account that is designated as being environmentally friendly. The bank offers an incentive that encourages their customers to either establish a new account or convert their existing account into the newly established environmentally friendly program. Once a customer is enrolled in the environmentally friendly program they are provided with services and account options that encourage them to use online bill payment, electronic statements and paperless charge transactions in exchange for reward payments. In this manner the greater advantage that the customers take of the environmentally friendly services and account options, the greater their reward payment will be. In other words, the bank is employing an incentive program to encourage the employees to transfer onto the new system and method.

In the new customer portion of the method, customers proceed into the traditional new customer intake process via a bank branch 2, a telephone 4 or an Internet web interface 6. These customers select from any of the normally available bank service packages to obtain the product that best fits them 8. During the enrollment process they also elect to enroll the account they selected 8 as an environmentally friendly account 10. Similarly, existing customers 12 can elect to enroll their existing accounts as environmentally friendly accounts 10. Should the customer not elect the environmentally friendly option, the account proceeds to a traditional style bank account 14. However, those that elect the environmentally friendly option 10 are flagged for entry to the incentive program 16. The flag provides an indication that the account is enrolled in the environmentally friendly option and allows the bank service provider and various partners to provide rewards and incentives to the customer 18.

Among the incentives that may be provided to the customers who establish or transfer to the environmentally friendly program are an electronic transaction card that is formed from 85% recycled plastic material, on-line banking and an electronic monthly statement thereby eliminating all of the paper associated with the ongoing management side of the account. Further the customers who enroll receive a reward. Such rewards may be provided for each and every payment or transaction that they complete without using paper or for some fraction or multiple of transactions completed without using paper. For example, customers who enroll in the program may be paid 10 cents for every payment they make without paper, up to a total of $120 annually. In the context of the present invention, payments without paper include debit card transactions (both signature and PIN), online bill payments and all automatic payments charged to a checking account or debit card. The incentive may be paid on a transaction-by-transaction basis or may be accumulated and deposited as cash directly into a customer's checking account on a monthly basis to provide greater savings and spending flexibility. While one example that employs specific reward amounts and a particular rewards payment scheme has been shown herein, it is intended to be illustrative of the concept and not limiting on the scope or manner in which the reward payment may be calculated or provided.

In an alternate embodiment, the incentive is accumulated as described above and deposited as cash directly into a customer's checking account on a monthly basis. To further encourage savings, the customer also designates a savings account that is registered with the program. When the incentive is deposited into the checking account, the amount of the incentive and a designated matching transfer are both deducted from the checking account balance and transferred as a deposit into the designated savings account. The designated matching transfer is preferably an amount that is deducted from customer funds that were already contained within the checking account. It is also preferable that the matching transfer be an amount equal to the amount of the incentive although other amounts may be employed and still fall within the scope of the invention. For example, if the incentive amount is $10 then the preferred matching transfer is in the amount of $10, however, the account may also include means for the customer to designate a higher or lower amount for use as the matching transfer.

Still further, the bank service provider may make an additional incentive to encourage participation in the program in the form of a bank funded matching deposit. The bank funded deposit may be deposited into the savings account at the time of the incentive and matching transfer transaction or may be accrued and transferred into the customer's account on a periodic basis such as monthly, quarterly or annually. The bank funded deposit may be in an amount that is equal to the base incentive amount. It is also within the scope of the present invention that the bank funded deposit may be determined as a percentage up to and including 100% of the incentive or as a percentage of the customer's matching transfer. Still further, the bank funded deposit may be tiered such that during an introductory period the bank funded deposit is equal to the initial incentive and then, after the introductory period expires, the bank funded deposit is calculated as a percentage of the incentive or matching transfer.

In an illustrative example, the customer enrolls a checking account and designates a savings account for participation in the program. The incentive amount is accrued as detailed above and deposited into the checking account on a periodic basis. In one period, accrued amount my equal $10. Once the $10 incentive amount is deposited into the checking account, the $10 incentive amount and a matching $10 from existing funds within the checking account are transferred as a net $20 deposit into the savings account. Further, the bank then accrues a bank funded deposit in a predetermined amount for later periodic deposit to the savings account. It should be appreciated that while specific accounts were described and a specific sequence and structure of deposits was detailed. The present invention is not limited in this manner as all deposits may be made straight to another form of account or transferred from another form of account without departing from the disclosure herein.

Additionally, the method and system of the present invention may provide that all customers enrolled in the program will receive a monthly e-mail to notify them of their monthly incentive deposit, provide green living tips and let them know the impact their participation in the program has made on the environment. Finally, a website may be also provided for customers to learn more about the program and how becoming eco-friendly can also be economical. At the website a calculator is provided to demonstrate to the customer the impact that going “paperless” will have.

It should be further appreciated by one skilled in the art that the process of tracking and distributing the various rewards and incentives may be done by the bank service provider themselves. Further, tracking and distributing the various rewards and incentives may be done by partners or affiliates of the bank service provider. In either case, the provider of the service itself does not alter the method of the present invention and any variation thereof is intended to fall within the scope of the present invention.

In terms of a system, the method of the present invention is implemented across the existing bank services systems as depicted in FIG. 2. A bank service provider establishes a new account on their bank computer system 20 that is designated as being environmentally friendly. The bank computer system 20 is connected to and accessible via a global computer network 22. The bank offers an incentive that encourages their customers to either establish a new account or convert their existing account into the newly established environmentally friendly program. Once a customer is enrolled in the environmentally friendly program, they are provided with services and account options that encourage them to use online bill payment via a user interface 24 that is connected to the global computer network 22. Further, the user interface 22 may be employed for accessing electronic statements and paperless charge transactions in exchange for reward payments. In this manner the greater advantage that the customers take of the environmentally friendly services and account options, the greater their reward payment will be. In other words, the bank is employing an incentive program to encourage the customer to transfer onto the new system and method. Additionally, a customer employs an electronic transaction card 26 in any PIN based or signature based transaction at a point of sale terminal 28 to complete a paperless transaction that accrues further rewards on a use-by-use basis.

It can therefore be seen that the present invention provides a method and system for offering an environmentally friendly bank program that takes the greatest advantage of the available electronic and paperless systems in use today and encourages customers, through the use of a rewards system, to maximize their usage of the electronic features available to them in order to reduce the paper generated in the management of their account. For these reasons, the invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of providing an environmentally friendly bank program comprising:
a bank service provider establishes a is fully paperless banking program, wherein customers participate in said program by using paperless transactional methods and designate at least one account that is linked thereto;
the bank service provider deposits into said at least one account an incentive based on tracking said paperless transactions;
segregating a portion of customer funds within said account equal to a percentage of said incentive.

2. The method of claim 1, wherein said percentage is 100%.

3. The method of claim 1, wherein said at least one account is one savings account and one checking account, said bank service provider depositing said incentive into said checking account, said customer funds being segregated within said checking account.

4. The method of claim 3, further comprising:
transferring said incentive and said segregated funds to said savings account.

5. The method of claim 1, further comprising:
accruing a matching transfer of bank provided funds equal to a percentage of said incentive, said matching transfer being periodically transferred to said at least one account.

6. The method of claim 5, wherein said bank provided funds percentage is 100%.

7. The method of claim 5, wherein said bank provided funds percentage is one value for an introductory period and a second value after said introductory period expires.

8. The method of claim 5, wherein said at least one account is one savings account and one checking account, said bank service provider depositing said incentive into said checking account, said customer funds being segregated within said checking account.

9. The method of claim 8, further comprising:
transferring said incentive and said segregated funds to said savings account; and
depositing said accrued matching transfer to said savings account.

10. The method of claim 1, further comprising:
accruing a matching transfer of bank provided funds equal to a percentage of said segregated portion of client funds for periodic transfer to said at least one account.

11. The method of claim 10, wherein said bank provided funds percentage is 100%.

12. The method of claim 10, wherein said bank provided funds percentage is one value for an introductory period and a second value after said introductory period expires.

13. The method of claim 10, wherein said at least one account is one savings account and one checking account, said bank service provider depositing said incentive into said checking account, said customer funds being segregated within said checking account.

14. The method of claim 13, further comprising:
transferring said incentive and said segregated funds to said savings account; and
depositing said accrued matching transfer to said savings account.

15. The method of claim 1, wherein said paperless transactional methods are selected from the group consisting of: online bill payment, electronic statements and paperless charge transactions.

16. The method of claim 1, wherein said incentive is a monetary amount that is awarded for each paperless transaction.

17. The method of claim 1, wherein the incentive is aggregated and provided to the customer on a periodic basis.
